(19) United States
(12) Patent Application Publication
(10) Pub. No.: US 2015/0296418 A1
(43) Pub. Date: Oct. 15, 2015

(54) Methods and Apparatus for Handover Management of Transfer Control Protocol Proxy Communications

(71) Applicant: Nokia Solutions and Networks Oy, Espoo (FI)

(72) Inventors: Peter Szilagyi, Budapest (HU); Zoltan Vincze, Kormend (HU); Csaba Vulkan, Budapest (HU)

(73) Assignee: Nokia Solutions and Networks Oy

(21) Appl. No.: 14/686,967

(22) Filed: Apr. 15, 2015

Related U.S. Application Data
(60) Provisional application No. 61/979,768, filed on Apr. 15, 2014.

(51) Int. Cl. H04W 36/00; H04L 29/06; H04L 29/08

(52) U.S. Cl. CPC H04W 36/0016; H04L 67/2847; H04L 69/161

(57) ABSTRACT

Systems and techniques for transport control protocol proxy mangement during handover of a user device from one base station to another. One or embodiments of the invention provide mechanisms to create a transport control protocol (TCP) proxy during establishment of a new data bearer establishment at an eNodeB, wherein the TCP proxy is integrated with a packet data convergence protocol (PDCP) buffer of the new bearer. The TCP proxy is configured so as to manage delivery of pre-fetched data to a user device so as to prevent TCP connection collapse during handover of the user device from a source eNodeB to a target eNodeB.

### CROSS REFERENCE TO RELATED APPLICATIONS

This Application claims Priority from U.S. Provisional Application Ser. No. 61/979,768, filed Apr. 15, 2014 and incorporated herein by reference in its entirety.

### TECHNICAL FIELD

The present invention relates generally to wireless communication. More particularly, the invention relates to mechanisms for efficient handover of transfer control protocol connections carried on using a transfer control protocol proxy.

### BACKGROUND

Following is a list of abbreviations and their expansions, useful in understanding various embodiments of the present invention:
ACK Acknowledgement
AM Acknowledged Mode
ARQ Active Repeat reQuest
AWND Advertised Window
DB Database
DL Downlink
DSCP Differentiated Services Code Point
EF Expedited Forwarding
eNB Evolved Node B
FEC Forward Error Correction
GPRS General Packet Radio Service
GTP GPRS Tunneling Protocol
HARQ Hybrid Active Repeat reQuest
IP Internet Protocol
LTE Long Term Evolution
MAC Media Access Control
MSS Maximum Segment Size
NZWA Non-Zero Window Advertisement
PDU Protocol Data Unit
PDCP Packet Data Convergence Protocol
PEP Performance Enhancement Proxy
QoE Quality of Experience
QoS Quality of Service
RLC Radio Link Control
RoHC Robust Header Compression
RX Receive
SACK Selective Acknowledgement
SAE-GW Service Architecture Evolution Gateway
SAP Service Access Point
TCP Transmission Control Protocol
TX Transmit
UDP User Datagram Protocol
UE User Equipment
UL Uplink
WS Window Scaling
ZWA Zero Window Advertisement

Modern communication systems have continuously become more and more widespread and are used more and more for data communication. Wireless communication networks have seen huge growth over the last several decades, and applications involving data communication and in particular packet-switched communication have proliferated more and more and occupy a much larger proportion of network capacity than in previous years, as compared to voice applications.

An important feature that has been key to the growth of wireless communication systems is handover. Wireless network coverage areas are divided into cells, with each cell being served by a base station or combination of base stations and other entities. When the signal conditions experienced by a mobile device deteriorate (often, because the mobile device is moving from the coverage area of one cell to that of another), the mobile device's serving base station can transfer responsibility for the mobile device to another base station. Efficient use of communication resources has always been important and is only becoming more important over time as the demands placed on network infrastructure and network frequencies increases. In addition, the need for reliability in data communication continues to increase with the increase in demand for data communication. One well-known flashpoint for inefficiencies and unreliability is handover, which involves recognition that a mobile device's radio conditions are deteriorating or likely will deteriorate, identification infrastructure to which a handover is to be made, signaling to accomplish the handover, and execution of the handover while maintaining an ongoing connection.

### SUMMARY

In an embodiment of the invention, an apparatus comprises at least one processor and memory storing a program of instructions. The memory storing the program of instructions is configured to, with the at least one processor, cause the apparatus to at least create a transport control protocol (TCP) proxy during establishment of a new data bearer establishment at an eNodeB, wherein the TCP proxy is integrated with a packet data convergence protocol (PDCP) buffer of the new bearer, and configure the TCP proxy so as to manage delivery of pre-fetched data to a user device so as to prevent TCP connection collapse during handover of the user device from a source eNodeB to a target eNodeB.

In another embodiment of the invention, an apparatus comprises at least one processor and memory storing a program of instructions. The memory storing the program of instructions is configured to, with the at least one processor, cause the apparatus to at least monitor end-to-end transfer control protocol (TCP) connections before, during, and after a handover and maintain a TCP segment cache comprising a copy of each data segment that has been acknowledged by an eNodeB side TCP proxy, monitor acknowledgements received in uplink, and if an acknowledgement received in uplink indicates data loss, retransmit the missing data from the cache.

In another embodiment of the invention, a method comprises creating a transport control protocol (TCP) proxy during establishment of a new data bearer establishment at an eNodeB, wherein the TCP proxy is integrated with a packet data convergence protocol (PDCP) buffer of the new bearer, and configuring the TCP proxy so as to manage delivery of pre-fetched data to a user device so as to prevent TCP connection collapse during handover of the user device from a source eNodeB to a target eNodeB.

In another embodiment of the invention, a method comprises monitoring end-to-end transfer control protocol (TCP) connections before, during, and after a handover and maintain, a TCP segment cache comprising a copy of each data segment that has been acknowledged by an eNodeB side TCP proxy, monitoring acknowledgements received in uplink, and, if an acknowledgement received in uplink indicates data loss, retransmit the missing data from the cache.

In another embodiment of the invention, a computer readable medium stores a program of instructions, execution of which by a processor configures an apparatus to at least create a transport control protocol (TCP) proxy during establishment of a new data bearer establishment at an eNodeB, wherein the TCP proxy is integrated with a packet data convergence protocol (PDCP) buffer of the new bearer, and configure the TCP proxy so as to manage delivery of pre-fetched data to a user device so as to prevent TCP connection collapse during handover of the user device from a source eNodeB to a target eNodeB.

In another embodiment of the invention, a computer readable medium stores a program of instructions, execution of which by a processor configures an apparatus to at least monitor end-to-end transfer control protocol (TCP) connections before, during, and after a handover and maintain a TCP segment cache comprising a copy of each data segment that has been acknowledged by an eNodeB side TCP proxy, monitor acknowledgements received in uplink, and if an acknowledgement received in uplink indicates data loss, retransmit the missing data from the cache.

### BRIEF DESCRIPTION OF THE DRAWINGS

FIG. 1 illustrates handover procedures using a hypothetical transmission communication protocol proxy;

FIG. 2 illustrates a network according to an embodiment of the present invention;

FIG. 3 illustrates architecture of a transport control protocol proxy according to an embodiment of the present invention;

FIG. 4 illustrates handover using an eNodeB side transport control proxy including X2 forwarding of pre-fetched data;

FIG. 5 illustrates eNB side mechanisms to prevent handover problems, according to an embodiment of the present invention;

FIG. 6 illustrates a core network side transport control protocol segment cache to provide for on-demand retransmission during handover;

FIG. 7 illustrates logical placement of a TCP proxy within an eNB according to an embodiment of the present invention;

FIG. 8 illustrates an interface of a transport control protocol toward a packet divergence control protocol network layer, according to an embodiment of the present invention;

FIG. 9 illustrates a per-connection attribute database maintained by a transport control protocol proxy, according to an embodiment of the present invention;

FIG. 10 illustrates status and transition of pre-fetched transport control protocol data segments according to an embodiment of the present invention;

FIG. 11 illustrates internal transport control protocol proxy architecture according to an embodiment of the present invention;

FIG. 12 illustrates a source transport control protocol proxy during handover, according to an embodiment of the present invention;

FIG. 13 illustrates packet data convergence protocol buffer content in a target eNodeB without transport control protocol proxy support capabilities, according to an embodiment of the present invention;

FIG. 14 illustrates eNodeB mechanisms to reduce the risk of connection collapse by packet loss during X2 forwarding, according to an embodiment of the present invention;

FIG. 15 illustrates a core side transport control protocol segment cache according to an embodiment of the present invention; and

FIG. 16 illustrates elements for carrying out one or more embodiments of the present invention.

### DETAILED DESCRIPTION

The Transmission Control Protocol (TCP) is the primary transport layer protocol used for data transfer (for example downloading content from the Internet) in today's computer and telecommunication networks. The TCP provides in-sequence, reliable data transfer between two protocol entities (the TCP sender and receiver) through mechanisms such as positive acknowledgement, slow start, fast retransmission, fast recovery and congestion avoidance.

Internet (and thus TCP-based) applications are increasingly accessed from mobile devices, and these devices are consuming more and more bandwidth and are frequently interactive so that numerous shifts occur between devices as to which device is the sender and which is the receiver. Therefore, efficient TCP operation in 3GPP environments is important from the perspectives of system operation and customer experience.

One widely used approach is to deploy a TCP Proxy for performance enhancement (often referred to as a Performance Enhancement Proxy, or PEP). A common variant of such an approach is a split connection TCP Proxy implementation, which intercepts the TCP handshake (connection establishment) between a mobile device (referred to as a UE in 3GPP and 3GPP LTE and LTE-A systems) and a content server, terminates the TCP connection towards the UE, and establishes a TCP connection towards the server on behalf of the UE. After the connection setup, the TCP Proxy operates the separate server side (upstream) and UE side (downstream) connections asynchronously. In a ubiquitous PEP deployment, the TCP Proxy must be transparent, i.e., requiring no awareness or configuration at the UE.

In LTE systems, suitable locations for a TCP Proxy are the core network, the service architecture evolution gateway (SAE-GW) and the eNB in a radio access network. At each location, the TCP Proxy achieves downlink throughput improvement (as compared to the case with no TCP Proxy) whenever the upstream connection can outpace the downstream connection. This condition is commonly satisfied in mobile access networks in which the radio interface is frequently the bottleneck. From the perspective of a TCP Proxy, the radio interface is always downstream. As the TCP Proxy operates the upstream and downstream connections asynchronously, it reduces the round trip time (RTT) in both segments compared to the end-to-end RTT. The performance of the TCP not only depends on the available bandwidth but also on the RTT, so that the TCP Proxy still improves the achievable throughput in the narrow downstream connection despite having no influence on the available bandwidth itself. Whenever the downstream connection is slower, the TCP Proxy can download data from the content server faster than transferring the data to the UE. That is, the TCP Proxy can maintain an advance in the download compared to the UE. The data already downloaded by the TCP Proxy but not yet forwarded to the UE is referred to as the pre-fetched data. The objective of pre-fetching data is not to asynchronously download and buffer the entire content requested by the UE but to have just enough data to keep the downstream connection busy whenever there is data to download, maximizing the throughput experienced by the UE.

A TCP Proxy deployed in the core or at the SAE-GW side is above the mobility anchor point of the UEs, so that LTE handovers require no support or even awareness from the TCP Proxy. However, these solutions can achieve only a limited gain for two main reasons. First, the TCP Proxy's efficiency is degraded due to its non-optimal location: that is, far from the proximity of the radio interface (which is often the bottleneck). Second, the core or SAE-GW side TCP Proxy must, in general, act as a TCP sender to the UE, as it must react to packet losses on the transport according to TCP congestion control. Due to TCP sender side mechanisms (such as slow start and congestion avoidance) the TCP Proxy may not be able to keep the radio sufficiently loaded with data, resulting in idle periods and loss of efficiency at the radio interface.

A TCP Proxy may be implemented in the eNB as well, and such an implementation may provide radio equipment designers to provide TCP optimization mechanisms. Such a positioning may prove optimum for the TCP Proxy due to the performance improvement it can provide at the eNB whenever the radio is the bottleneck in the end-to-end context. Additionally, the eNB side TCP Proxy has an opportunity to optimize its data delivery mechanism towards the UE by efficiently using the services provided by the LTE radio stack, resulting in an improved interworking between the TCP and the LTE radio interface.

Such a deployment, however, requires special mechanisms are needed to handle TCP flows during handover. In order to prevent causing TCP collapse (from which there may be no recovery), all pre-fetched data (required for enhanced performance) must be reliably transferred to the target eNB or to the UE. If the TCP Proxy fails to ensure the error free delivery of the pre-fetched data, the TCP connection will collapse after handover because, in general, no other mechanism exists to recover the lost data afterwards. The content server is not configured to retransmit any of the pre-fetched data as it has already been acknowledged by the TCP Proxy. On the other hand, the TCP Proxy at the source eNB cannot retransmit the data to the UE because the uplink (UL) acknowledgements (ACKs) are not forwarded to the source eNB after the handover.

There may be multiple approaches to circumvent the above handover problem in an eNB side TCP Proxy. One possibility is to delay the handover until the pre-fetched data is transferred completely to the UE. However, the reason for handover is often a deteriorating signal environment for a UE, so that the signal quality of the source eNB may be poor by the time a handover is triggered. The required delay may there be indefinitely long or the transfer may be unsuccessful. Another approach is to predict the handovers based on the radio measurement reports received from the UEs and in case the likelihood of handover is increasing, decrease (and eventually eliminate) the amount of the pre-fetched data by delaying the ACKs sent in the upstream connection to the content server. However, this solution itself cannot guarantee that TCP collapse is avoided in each and every case as handovers may not always be predicted early enough. Additionally, in case of false predictions the performance of the TCP Proxy is negatively impacted as the amount of pre-fetched is decreased unnecessarily.

In order to address these and other problems, one or more embodiments of the present invention provide for a TCP Proxy architecture that is integrated with the packet data convergence protocol (PDCP) layer of the LTE eNB. Such an approach allows for full utilization of radio protocol stack services for optimal performance; second, the approach allows the TCP Proxy to store the pre-fetched data directly in the (PDCP) buffer, which is a key enabler for the handover friendly operation.

In order to handle packet losses from the pre-fetched data during handover, various embodiments of the invention provide for two alternative solutions. In one embodiment, a radio side solution extends the source and target eNBs with mechanisms to prevent packet losses or recover from detected losses between the source and target eNBs. The second alternative introduces a core side entity, referred to as the TCP Segment Cache, to provide TCP retransmissions on behalf of the content server whenever a pre-fetched data segment is lost between the eNBs during handover. The core side TCP Segment Cache does not need any support from the target eNBs, being a fully valid solution alternative to prevent the handover problem even if the target eNB does not support TCP Proxy functionality.

Implementation of a TCP Proxy at the eNB creates, as noted above, potential difficulties related to efficiency and reliability. The eNB side TCP Proxy has two potential shortcomings as listed below.

(A) The first and most prominent problem is that the eNB side TCP Proxy may inherently cause the collapse of TCP connections after handover.

(B) The second problem is an efficiency issue arising when the TCP Proxy is not fully integrated with the LTE radio protocol stack.

The details of the problems and their solution according to this invention are discussed below.

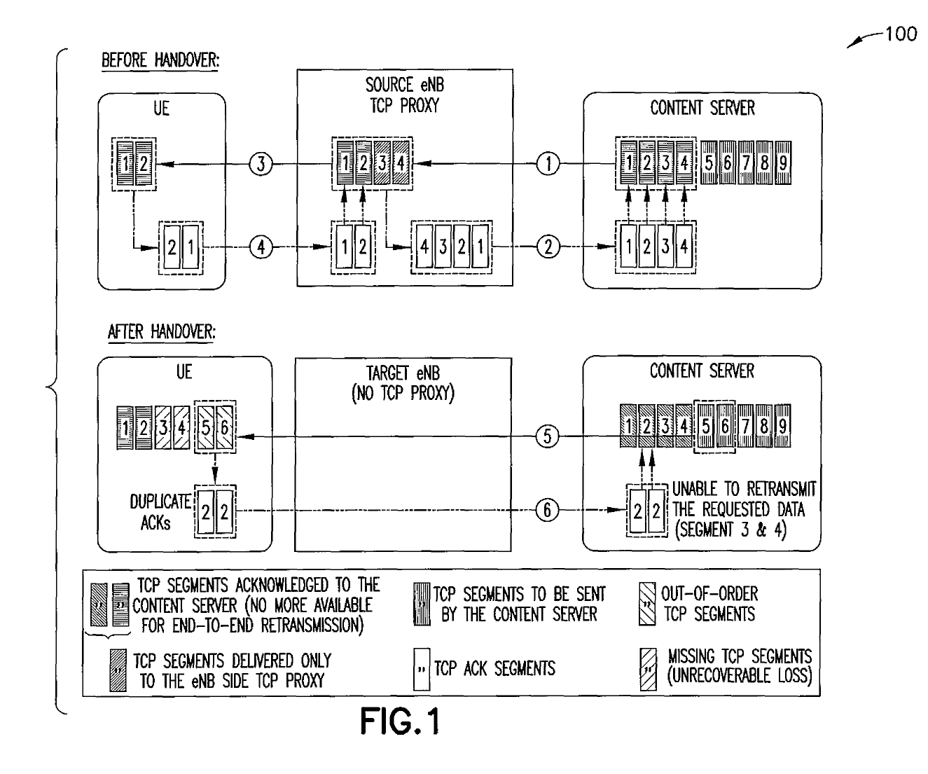

(A) The handover problem is rooted in the reason for deploying a TCP Proxy at the eNB side. The TCP Proxy is required to pre-fetch data from the content server in order to provide reasonable throughput improvements. In order to maintain its advantages, the TCP Proxy needs to asynchronously acknowledge the pre-fetched data to the content server before it is transmitted to the UE. As data is acknowledged, the content server removes the data from its context. Such data will then no longer be present at the server. If the pre-fetched data is unable to be reliably delivered to the target eNB during the handover, the data will be irrecoverably lost and the corresponding TCP connections will collapse. Neither the content server (which no longer has the data available) nor the TCP Proxy (for LTE architectural reasons) can retransmit the pre-fetched data lost during the handover. If the TCP Proxy were deployed without the asynchronous acknowledgement mechanism, data loss during handover could simply be recovered through retransmissions from the content server. However, such an approach frustrates the very reason of having the TCP Proxy in the first place. The problem is illustrated by FIG. 1, which presents a diagram 100 of the handover process as described above.

Lossless forwarding of the pre-fetched data during handovers is therefore important for seamless TCP Proxy operation. Data loss might occur for various reasons. First, the LTE handover mechanism continues forwarding the PDCP packet data units (PDUs) over an X2 connection only until an S1 path switch is executed. At that point, the SAE-GW sends a GTP end marker packet to the source eNB to indicate that no more data is to be received on the original S1 path. If the eNB side TCP Proxy has not managed to convert all of its pre-fetched data to PDCP PDUs before that, the remaining data will be stuck at the source eNB TCP Proxy. The same problem occurs if the general packet radio services (GPRS) tunneling protocol (GTP) end marker timer expires at the target eNB, at which point it stops accepting forwarded data from the source eNB even if no GTP end marker was received (for example, because the end marker was itself lost on the transport). Finally, even if the TCP Proxy successfully manages to make all pre-fetched data subject of the X2 forwarding mechanism, the forwarded segments may still be discarded on the transport links. As the X2 forwarding is not a guaranteed delivery service, the discarded packets will be permanently lost.

One or more embodiments of the present invention provide for a TCP Proxy architecture that keeps the pre-fetched data in the PDCP buffer. Such an approach helps to ensure that all pre-fetched data will be included in the X2 forwarding. In one embodiment, an eNB side only solution enriches the source and target eNBs (or TCP Proxies) with functionalities to prevent losses or fully recover the lost data. In alternative or additional embodiments, an additional core side entity acts on behalf of the content server and retransmits all segments that are lost from the pre-fetched data during handover.

(B) The second problem with an eNB side TCP Proxy that is unless it is fully integrated with the LTE radio stack, it has to operate as a generic TCP sender towards the UE. However, such operation interferes with the behavior of the LTE radio stack and causes inefficient operation. The LTE radio stack consists of the PDCP, radio link control (RLC) and media access control (MAC) protocol layers. The RLC Acknowledged Mode (AM) used for the data bearers guarantees that all data passed to the PDCP layer is eventually transmitted to the UE over the air interface. The reliable data transfer is provided by the MAC HARQ and RLC ARQ mechanisms. If an eNB side TCP Proxy acts as a TCP sender, including congestion avoidance and timeout mechanisms, it may induce duplicate data transmission or unnecessary reduction of the potential sending rate. Duplicate data is injected in case the TCP sender entity times out and begins retransmitting data segments that have already passed to the PDCP layer. Since in this case the PDCP/RLC layer still has the copy of the original data and tries to transfer it to the UE, this retransmission is unnecessary. Additionally, reverting to slow start after timeout would constrain any recovery occurring after the available capacity on the radio channel increases and allows data to be transferred at a high rate.

In one or more embodiments of the invention, a TCP proxy is The TCP Proxy architecture introduced in this invention eliminates the above problems as it is integrated with the PDCP buffer of the eNB in order to leverage all potential simplifications and gains supported by the underlying RLC AM infrastructure. Consequently, such a TCP Proxy does not suffer the congestion avoidance and timeout mechanisms towards the UE, thus avoiding the problems discussed above and boosting data transfer whenever conditions permit.

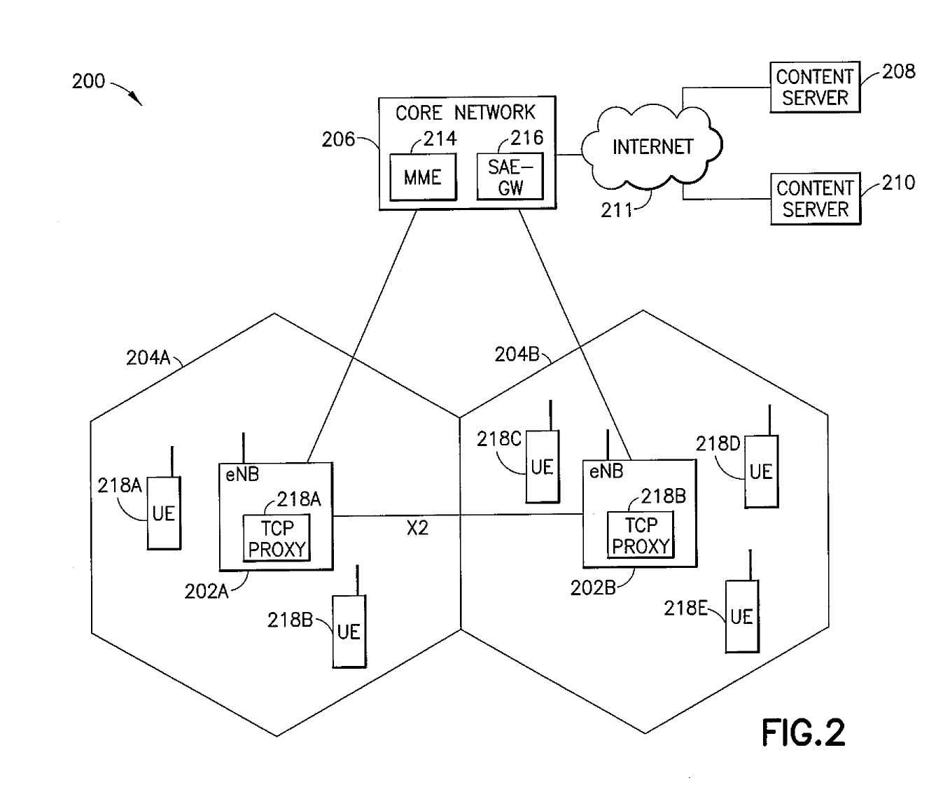

FIG. 2 illustrates a network 200 according to an embodiment of the present invention. The network comprises eNBs 202A and 202B, whose coverage area defines cells 204A and 204B. The network 200 further comprises a core network 206, with which the eNBs 202A and 202B communicate through S1 communications. The core network 206 provides management services to the network as well as access to outside entities, such as, for example, content servers 208 and 210, which may communicate with the core network 206 through the public interne 212. The eNBs 202A and 202B may gain access to the content servers 208 and 210, as well as other outside entities, through a TCP connection routed through the core network 206. The eNBs communicate with one another through an X2 connection. The core network 206 comprises a mobility management entity 214 and a service architecture evolution gateway (SAE-GW) 216 to provide support for radio access services and other services to the eNBs 202A and 202B and other network components. In one or more embodiments of the invention, the network 200 is a 3GPP LTE network, and may comprise all components understood in the art to be provided as part of a 3GPP LTE network.

The eNBs 202A and 202B serve UEs 218A-218E, which may move within and between the cells 204A and 204B, with the cells 204A and 204B handing off one or more UEs to one another as needed. The eNBs 202A and 202B implement TCP proxies 220A and 220B, respectively, which operate as described in greater detail below.

One or more embodiments of the present invention provide for an eNB integrated TCP Proxy architecture that provides for advantages in at least two domains. First, the TCP Proxy is fully integrated with the packet data convergence protocol (PDCP) layer, allowing for more efficient operation through optimal cooperation with the LTE radio protocol stack. Second, TCP Proxies according to one or more embodiments of the invention do not present the handover problem that is inherently introduced by a simple TCP Proxy deployed at the eNB side. Therefore, a TCP Proxy according to one or more embodiments of the invention is able to maximize the throughput gain by pre-fetching sufficient amount of data from the content server without the danger of TCP connection collapse after handover. In one or more embodiments, the TCP Proxy architecture presented here provides all benefits even if the TCP Proxy is not deployed in all eNBs in a network. In particular, the handover problem discussed above can be avoided even if the target eNB has neither the TCP Proxy nor any additional supporting mechanism to cooperate with a TCP Proxy at the source eNB. Such a capability provides for relatively easy implementation in multi-vendor heterogeneous networks.

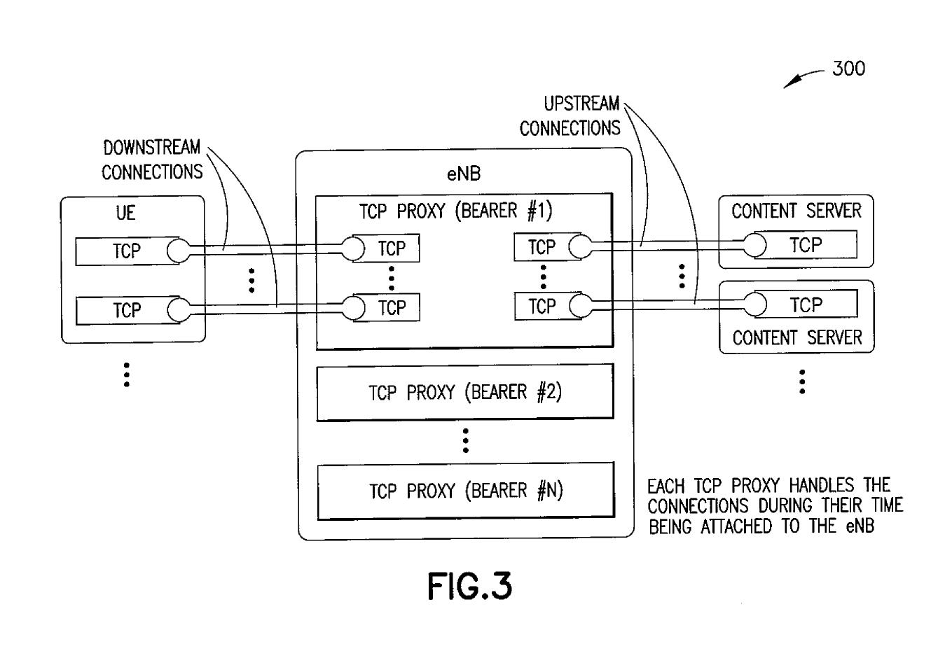

FIG. 3 illustrates an eNB side TCP Proxy architecture 300 according to one or more embodiments of the present invention. An eNB side transparent TCP Proxy is created during the data bearer establishment process and integrated with the PDCP buffer of the new bearer. A separate TCP Proxy instance is created for each data bearer that handles each or at least a relevant subset of the TCP connections within the bearer. The TCP Proxy maintains a reasonable (but not unlimited) amount of pre-fetched data for each connection being handled, in order to fully harvest the potential throughput gain. Additionally, the TCP Proxy optimally uses the services of the LTE radio protocol stack to transfer data to the UE as efficiently as possible.

The operation of the TCP Proxy is transparent to the end devices and it does not require any modifications, support or configuration either at the UE or at the content server. The TCP Proxy intercepts TCP connection establishments originated by the UE or the content server and creates the corresponding separate upstream and downstream TCP connections, effectively splitting the end-to-end TCP connection. The TCP Proxy synchronizes the connection establishment between the UE and the content server in order to preserve the end-to-end context of the TCP sequence and ACK numbers and other TCP options such as the window scaling factor or the usage of optional TCP mechanisms such as SACK and Timestamps. This approach allows the UE and the server to continue communication (earlier ongoing on the two separate connections) directly, which is mandatory in case the UE is handed over to a target eNB without TCP Proxy. After a connection has been established, the TCP Proxy acknowledges data as soon as it is received in an upstream connection, and then forwards it to the UE in the corresponding downstream connection by optimally using the services provided by the LTE radio stack. This mechanism ensures that the TCP Proxy is capable of harvesting all the potential available throughput improvement.

In one or more alternative or additional embodiments of the invention, the split TCP Proxy functionality may be applied only to a selected set of the TCP connections. For the other bypassed connections, the TCP Proxy becomes a passive monitoring entity that only follows their state but preserves the end-to-end TCP connectivity by transparently forwarding data between the UE and the content server—that is, it does not generate ACKs on behalf of the UE). Additionally, a data bearer may transfer not only TCP segments but UDP datagrams as well. Due to PDCP integration, the TCP Proxy receives also these datagrams; the TCP Proxy recognizes and forwards them between the UE and the content server transparently (similarly to the bypassed TCP connections that are not in the scope of the split TCP Proxy functionality).

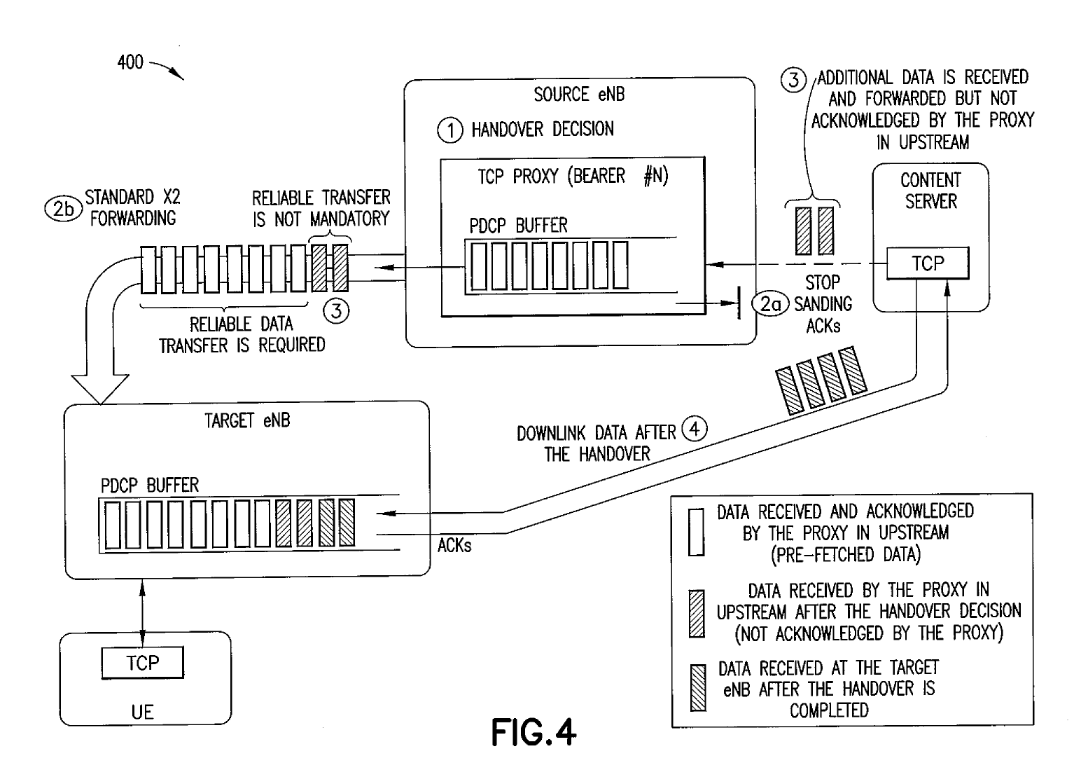

One or more embodiments of the invention provide for improved throughput via pre-fetching data without potentially causing TCP connection collapse during or after a handover. When the eNB makes a handover decision for a UE, all pre-fetched data is forwarded to the target eNB as part of the standard X2 forwarding procedure, of which FIG. 4 presents a diagram 400.

After the handover has been completed, the UE and the content server may continue communication directly—that is, without relying on a TCP Proxy in the target eNB. Alternatively, if the TCP Proxy is also deployed at the target eNB, the target TCP Proxy is able to continue to manage the already established and transferred TCP connections as well, just as if the connections were originated through the target eNB.

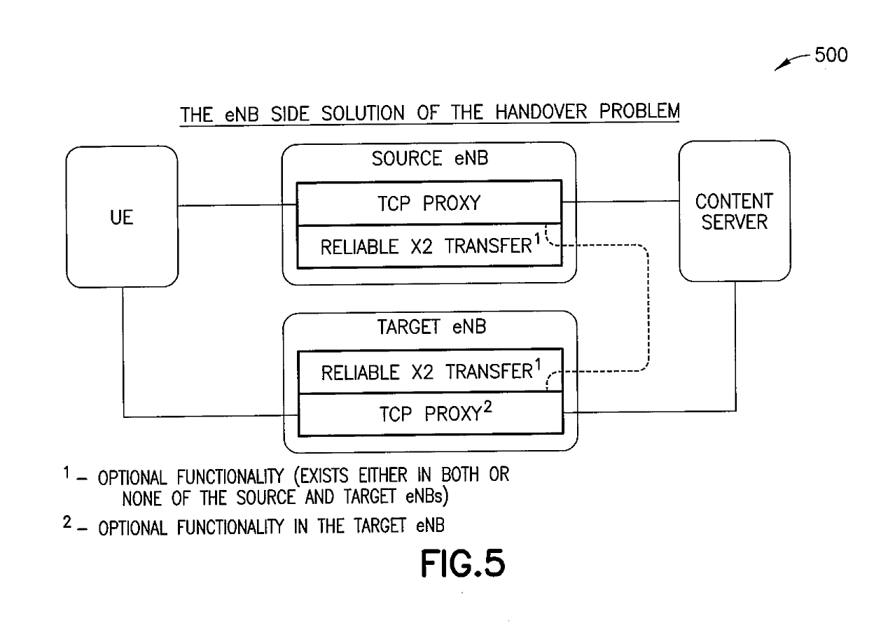

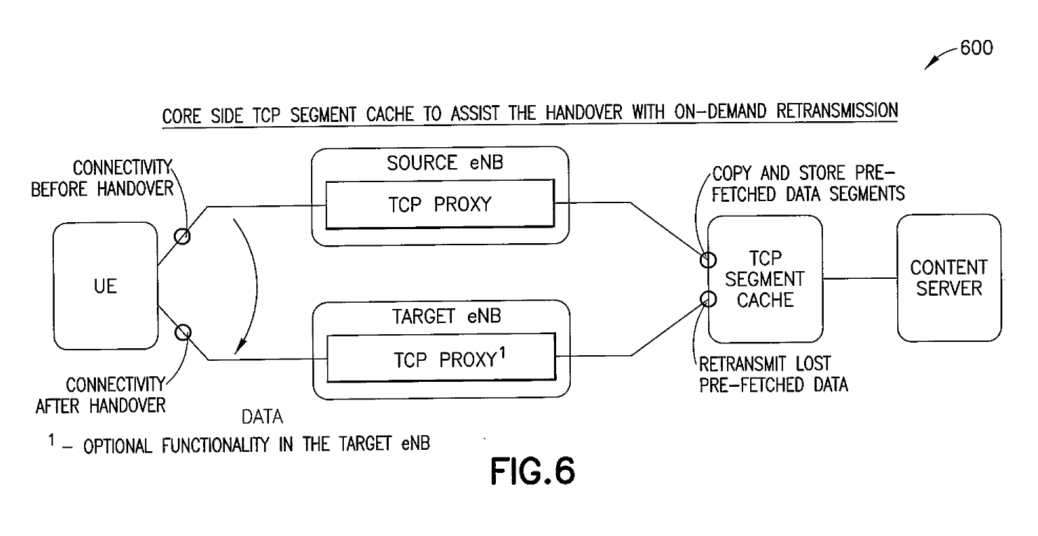

Forwarding all pre-fetched data from the TCP Proxy to the target eNB via X2 is the one mechanism for preventing unrecoverable data loss during handover. If this is performed, the only case when the TCP connections may still collapse after the handover is the case in which a pre-fetched data segment is lost on the transport during the X2 forwarding itself. One or more embodiments of the present invention provide for alternative ways to handle such losses through extra functionalities either at the eNB side, of which FIG. 5 presents a diagram 500, or through additional core side functionalities (FIG. 6).

The eNB side approach illustrated by the diagram 500 of FIG. 5 provides for additional functionalities for the TCP Proxy: reliable X2 transfer and prioritization of forwarded traffic. Such reliable X2 transfer requires support from both the source and target eNB (either integrated with the source and target TCP Proxy instances or as a separate functionality). Such mechanisms may include, for example error correction codes, increased redundancy, explicit ARQ or any other technique that guarantees lossless data transfer between the source and target eNB. Prioritization of forwarded traffic, without more, nevertheless provides for a significant decrease of the risk of transport losses. It is simple to implement but does not provide for a hard guarantee that no forwarded data segments will be lost.

In one or more alternative or additional embodiments of the invention (illustrated at FIG. 6, presenting diagram 600, a core side solution provides for an additional TCP Segment Cache, which is a software entity running on or attached to the SAE-GW or as a standalone network element deployed on the Gn/SGi interfaces. The cache is deployed above the mobility anchor point, and so is in a position to monitor the end-to-end TCP connections before, during and after handover. The cache is lightweight as it does not implement split TCP Proxy functionality—that is, it does not send ACKs on behalf of the UE. The function of the cache is to maintain a copy of the data segments that have already been acknowledged by the eNB side TCP Proxy (in which case the data is no longer available in the content server). Additionally, the cache monitors the ACKs it receives in uplink. If a data segment pre-fetched in the eNB side TCP Proxy is lost during the handover, the TCP Segment Cache detects the loss from the ACKs and retransmits the missing data from its cache. Since data that has already been acknowledged by the UE need not be retained, the TCP Segment Cache purges data that may no longer be required. The amount of data that needs to be retained is the maximum amount of data that may be pre-buffered at the eNB side TCP Proxy, which corresponds to the configured maximum per-bearer memory at the eNB. If the TCP Segment Cache is deployed, there is no need for a radio side reliable X2 transfer or for forwarded traffic prioritization mechanisms. However, such functionality (particularly in lightweight versions) may still be implemented to reduce the need for core side recovery).

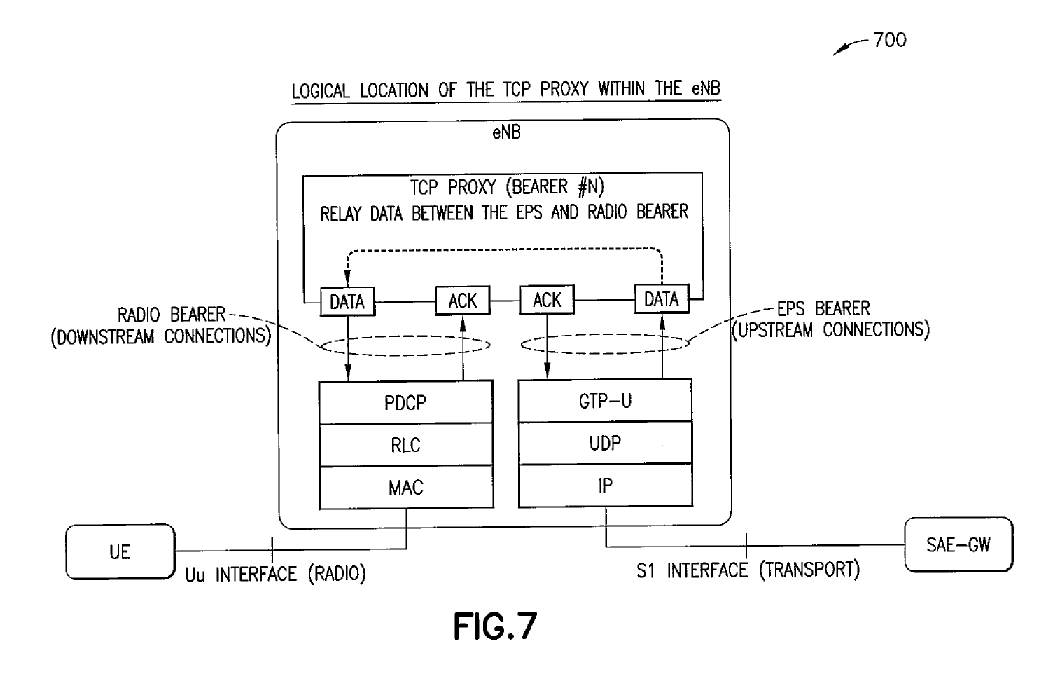

In one or more implementations, the TCP Proxy is a software entity running in the eNB with the scope of managing TCP connections established through a data bearer. Accordingly, the instances of the TCP Proxy may be created and terminated dynamically as part of the data bearer establishment/deactivation procedure, thus there are as many TCP Proxy instances in an eNB as the number of active data bearers. An end-to-end data bearer consists of a radio bearer (between the eNB and the UE) and an EPS bearer (between the eNB and the SAE-GW), with the eNB maintaining a one-to-one mapping between the two parts. The TCP Proxy receives data from the upstream connections that arrive at the eNB in the EPS bearer (S1 transport interface) and transmits data to the UE in the radio bearer (Uu interface) via the PDCP layer (as illustrated in FIG. 7, presenting a diagram 700) effectively relaying data between the two parts of the end-to-end bearer. The TCP Proxy generates and sends upstream ACKs on the S1 interface and receives ACKs sent by the UE from the PDCP layer.

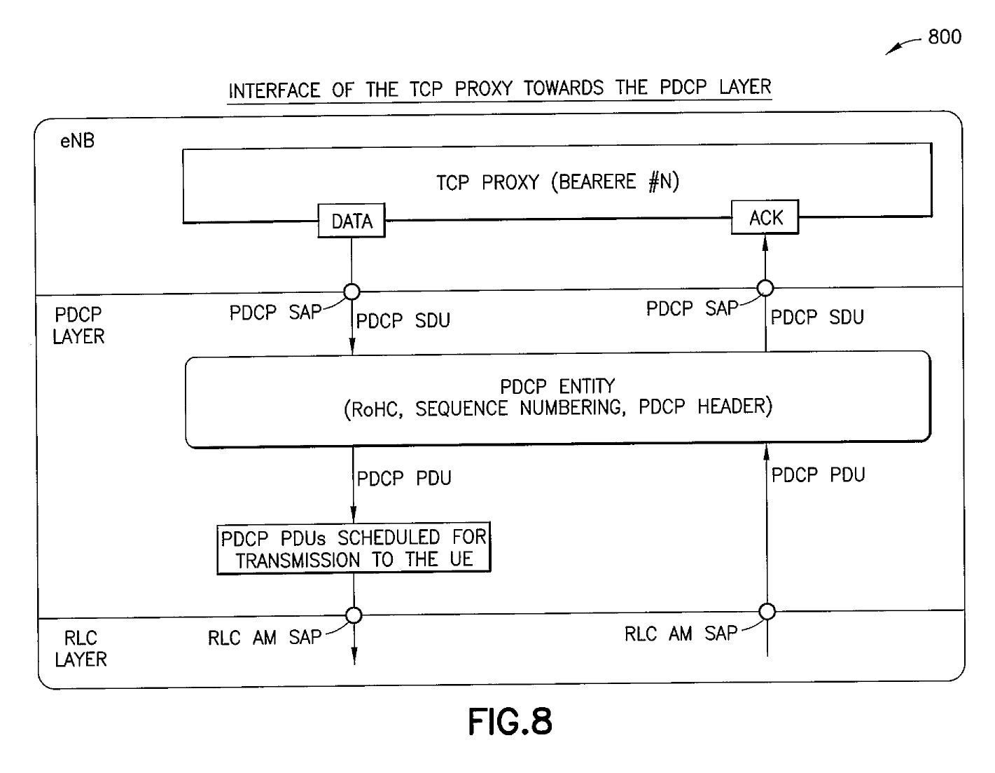

The TCP Proxy interfaces with the PDCP layer of the eNB via the 3GPP standard PDCP service access point (SAP) (as illustrated in FIG. 8, presenting a diagram 800). The TCP Proxy requires that the bearer is mapped to an RLC Acknowledged Mode (AM) entity. Data passed to the PDCP layer is first processed by the PDCP entity of the bearer to create a PDCP PDU by performing Robust Header Compression (RoHC) and PDCP sequence numbering. The resulting PDU is stored and scheduled for transmission to the UE.

Following are discussions of general and handover-specific operations of the TCP Proxy according to one or more embodiments of the invention. The discussion focuses primarily on downlink TCP data transmission by way of example, but it will be recognized that the same or similar architecture is able to address uplink data transmission as well.

In one or more embodiments of the invention, a TCP Proxy operates as a split connection proxy between the UE and the content server. The TCP Proxy examines each traversing packet in the data bearer in order to detect the establishment of new TCP connections (identified by a SYN flag set in the TCP header). The initial SYN, SYN/ACK and ACK segments (three-way TCP handshake) are forwarded by the TCP Proxy between the UE and the content server without modification in order to allow the end devices to establish and synchronize the end-to-end context of the new TCP connection. In particular, IP address and TCP port pairs, initial sequence number, window scaling factor and the usage of TCP options such as selective acknowledgement (SACK) or Timestamp, need to be negotiated or announced (ie., chosen) by the UE and the content server. Keeping the end-to-end context of the TCP connections makes it possible later for the TCP Proxy to return the connection directly to the UE and content server (i.e., joining) without compromising their ability to exchange data directly (i.e., after handover with no TCP Proxy at the target eNB).

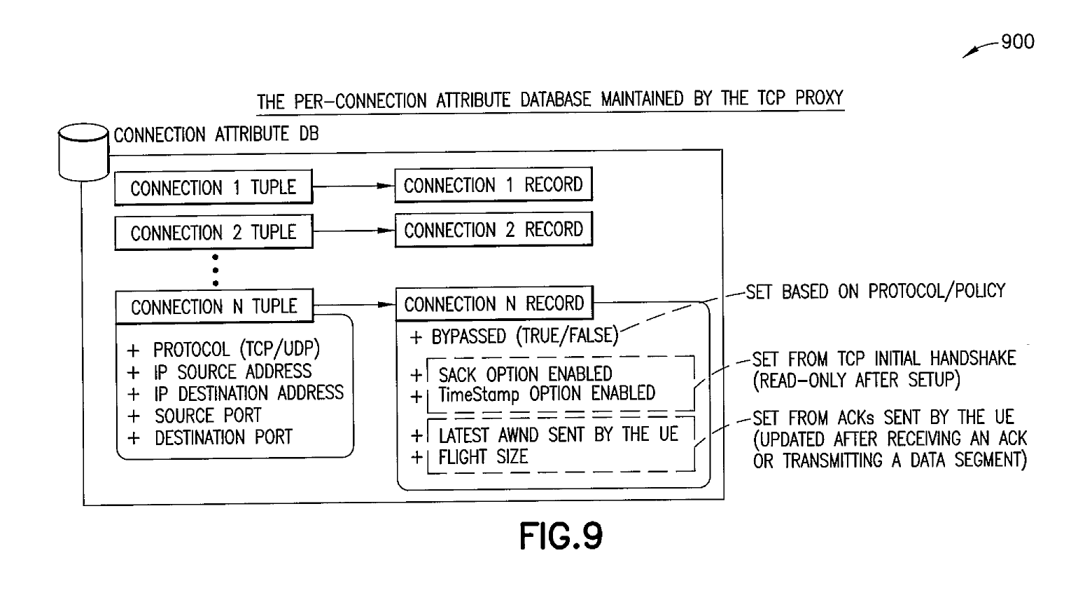

Upon the detection of new connections, the TCP Proxy populates a connection attribute database, illustrated in FIG. 9, presenting a diagram 900, that stores information about all TCP and non-TCP connections in the corresponding bearer. The database can be queried by the connection tuple, which is composed of the protocol, the source/destination IP addresses and TCP/UDP ports. These ports are not used for other protocols that have no concept of ports. This approach enables a common tracking of TCP and non-TCP connections. Each connection tuple indexes a connection record. A common field present in each record (regardless of the protocol) is a Boolean “bypassed” flag, which if true indicates that the corresponding connection is not subject to the split TCP Proxy functionality. For non-TCP connections this is true by definition, whereas for TCP connections this can be set based on a policy (for example, defining which connections are not to be proxied).

At the handshake of each TCP connection, the TCP Proxy records additional attributes—that is, whether the usage of SACK and TimeStamp options are enabled. Once set, these attributes are not modified later on. Additionally, during the data transfer, the TCP Proxy continuously records and updates two additional attributes: the current advertised window (AWND) as sent by the UE in the latest ACK, and the flight size. The flight size is the amount of data handed over to the PCDP layer but not yet acknowledged by the UE. The TCP Proxy should take the AWND into account to prevent sending more data to the UE than it is willing to accept, thus implementing TCP flow control functionality). The AWND is initialized from the first segment transmitted by the UE (usually the SYN) and updated later each time the TCP Proxy receives an ACK from the UE. The flight size is initialized to zero and it is updated each time an ACK is received from the UE (decreasing the flight size) or a data segment is handed over by the TCP Proxy to the PDCP layer (increasing the flight size). Since the connection tuple is present in all TCP segments (both data and ACK), retrieving the attributes corresponding to the connection is possible based on the packet headers.

After the successful completion of the TCP handshake, the data transfers in the corresponding upstream and downstream connections are not synchronized. If the TCP Proxy receives a data segment in an upstream connection, it acknowledges the data immediately (using the UE's TCP/IP identity as source address and port) without first passing it to the corresponding downstream connection and waiting for an ACK from the UE. Due to the fully synchronized TCP context between the UE and content server, the received TCP segments (including the TCP/IP headers) are not modified by the TCP Proxy. This approach has the added advantage that the end-to-end context of the TCP PSH and URG flags as well as the urgent pointer are also preserved without a need for additional book-keeping. Additionally, the MSS option is preserved (if it was present in the SYN or SYN/ACK segments).

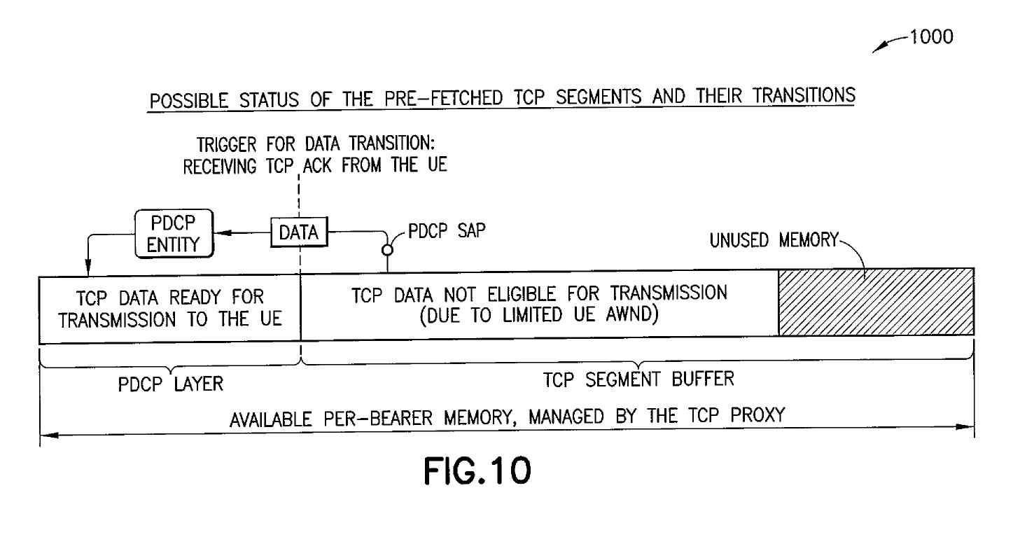

If the standard PDCP architecture (as illustrated, for example, in FIG. 8) is used, data passed to the PDCP layer cannot be retrieved or modified and it is likewise not possible to advance or delay its transmission to the UE. Therefore, in order for the implementation to remain compatible with the PDCP standard, the TCP Proxy may suitably be designed to operate within the limit of this constraint. In practice, this means that the TCP Proxy may pass a TCP data segment (received from the content server) to the PDCP layer only if UE is willing to accept more data—if the TCP connection's receive window advertised by the UE is larger than the amount of data already being scheduled for transmission. Accordingly, the total amount of memory (buffer space) available per bearer (the PDCP buffer) is used to store TCP data segments in two possible states from the delivery point of view (as illustrated in FIG. 10, presenting a diagram 1000).

First, if the data received from the content server fits into the UE's advertised window and there is free buffering space within the PDCP layer, it is passed directly to the PDCP entity of the bearer. The PDCP entity converts the TCP segments to PDCP PDUs and schedules them for transmission to the UE. Additional data that has been received from (and acknowledged to) the content server is stored by the TCP Proxy in a TCP segment buffer until new acknowledges are received from the UE. The received acknowledgements trigger the transition of data (up to the captured AWND size) from the TCP segment buffer to the PDCP SAP.

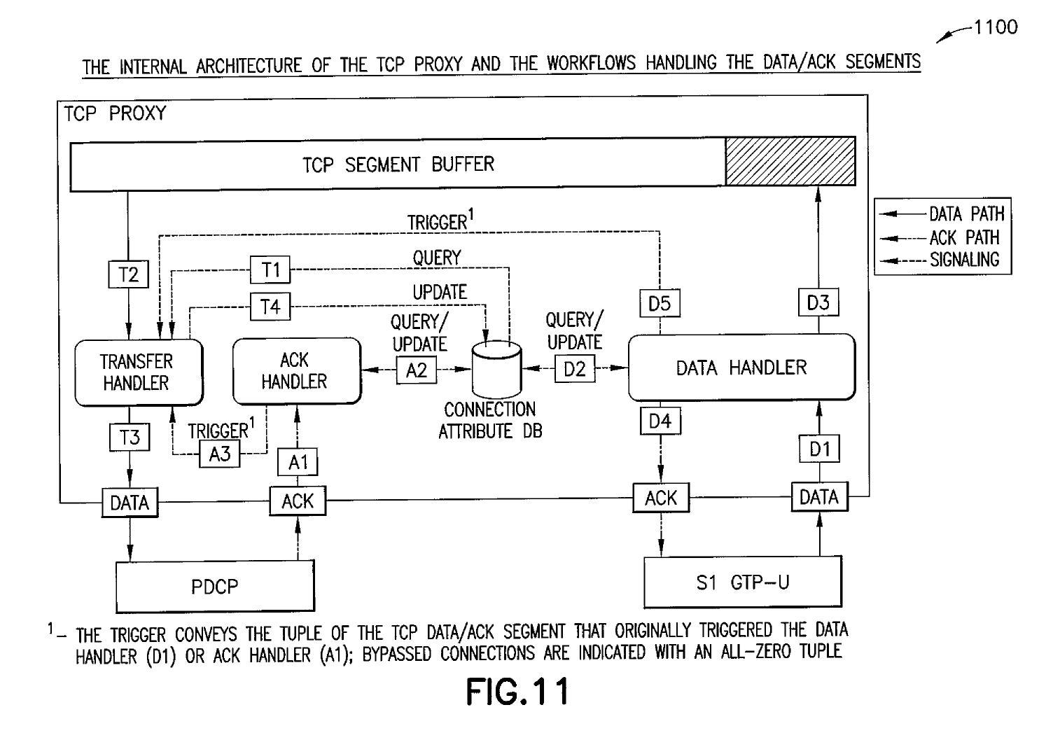

The internal architecture of the TCP Proxy is shown in FIG. 11, presenting a diagram 1100. The operation of the TCP Proxy is arranged along three workflows, executed by three corresponding logical entities: the data handler, the ACK handler and the transfer handler. The data handler (workflow D1-D5) is triggered by the reception of data from the content server and it is responsible for inserting the incoming data segment into the TCP segment buffer and to generate the corresponding ACK towards the content server. The ACK handler (workflow A1-A3) is triggered by receiving ACKs from the UE and its responsibility is to update the connection attributes. Both the data handler and the ACK handler trigger the third entity, the transfer handler at the end of their own workflow. The transfer handler (workflow T1-T4) is responsible for moving data from the TCP segment buffer to the PDCP layer while conforming to the connection's AWND limitation—that is, implementing flow control towards the UE.

The data handler is activated by each DL packet arrival on the S1 interface (step D1). If the per-bearer memory limit is reached, the packet is discarded. Otherwise, the data handler retrieves the attributes corresponding to the connection tuple defined by the packet headers (step D2). If no record is found for the tuple, a record is created and populated. For non-bypassed TCP connections, the data handler examines the sequence number of the TCP data segment (used for creating the ACK) and inserts it at the end of the TCP segment buffer (step D3). Next, the data handler generates the ACK towards the content server (step D4) according to standard TCP receiver behaviour and the attributes negotiated during the TCP handshake (for example, whether to use SACK and/or TimeStamps, available from the connection attribute database). Finally, the data handler triggers the transfer handler (step D5) to ensure that data is transmitted to the PDCP layer if possible. The trigger conveys the TCP/IP port/address tuple of the TCP data segment received in step D1. This is required to inform the transfer handler about the identity of the connection whose state has been changed.

For bypassed connections (for both TCP and non-TCP), the operation of the data handler in step D1-D3 exhibits two differences from that discussed above for non-bypassed connections. First, the ACK generation (step D4) is skipped altogether; second, the transfer handler is triggered (step D5) without indicating any connection tuple (for example, using zero addresses/ports to indicate that the trigger corresponds to a bypassed connection).

The ACK handler is activated by each UL packet that arrives at the air interface sent by the UE (step A1). The ACK handler retrieves the attributes corresponding to the connection tuple defined by the packet headers (step A2). In case no record is found for the tuple, one is created and populated. For non-bypassed TCP connections, the ACK handler examines the acknowledgement number of the TCP ACK segment and updates the flight size connection attribute according to the amount of acknowledged data (step A2). Additionally, the ACK handler updates the AWND attribute of the connection to the value in the ACK segment. After the update is completed, the ACK is discarded in case it is a pure ACK (i.e., contains no data). If the ACK is piggy-backed to an uplink data segment, the TCP Proxy forwards the segment to the content server. Finally, the ACK handler triggers the transfer handler (step A3) to make sure that data is transmitted to the UE if possible (e.g., due to the reduced flight size or due to increased AWND sent by the UE). The trigger conveys the connection tuple of the TCP ACK segment received in step A1.

If the query in step A2 indicates that the packet corresponds to a bypassed connection, the ACK handler simply forwards the packet the content server over the S1 GTP-U interface. Additionally, similarly to the data handler, the trigger for the transfer handler (step A3) carries a zero tuple.

The transfer handler is activated by either the data handler (step D5) or the ACK handler (step A3). If the trigger corresponds to a non-bypassed connection (non-zero tuple), the data handler queries the flight size and AWND attributes corresponding to the received connection tuple (step T1). Additionally, the transfer handler examines the TCP segment buffer and counts the amount of data in the buffer corresponding to the given connection (step T2). The amount of data (denoted by D) that the transfer handler can pass to the PDCP layer is given by the following formula:

D=min(AWND−flight_size, B) (Eq. 1)

where flight_size is the connection's flight size (queried from the attribute database) and B is the amount of data in the TCP segment buffer corresponding to the connection. In case D is zero or less than the size of the first data segment of the connection, the transfer handler will stop its workflow here (i.e., steps T3 and T4 are skipped). Otherwise, the transfer handler removes the corresponding TCP data segments from the TCP segment buffer and transfers them to the PDCP layer through the PDCP SAP (step T3) and updates the connection's flight size in the attribute database accordingly, i.e., the flight size is increased by D (step T4).

When the transfer handler receives a trigger with zero tuple (for example, a trigger on bypassed connection), it examines the first segment in the TCP segment buffer and transfers the segment to the PDCP layer if it corresponds to a bypassed connection. The operation is repeated until the TCP segment buffer is empty or its first segment corresponds to a non-bypassed connection. Additionally, the same operation is executed whenever at any point of its operation the transfer handler detects that the first segment in the TCP segment buffer corresponds to a bypassed connection. That is, the workflow of the transfer handler always makes sure that whenever it ends, the TCP segment buffer is either empty or its first segment is not bypassed).

The integrated TCP Proxy architecture discussed here uniquely optimizes its behaviour in the downstream by relying on the services provided by the LTE radio protocol stack as follows. Since the data bearers are mapped to RLC AM, the data transfer between the eNB and the UE is guaranteed via built-in retransmission mechanisms (MAC HARQ and RLC ARQ) even in case of air interface losses. This makes it possible for the TCP Proxy to completely eliminate the congestion window concept from its operation and send data received from the content server to the UE as fast as its advertised window allows. Thus, the TCP Proxy speeds up data transmission at the beginning of new connections over the air interface in cases in which pre-fetched data is already available from the content server. This approach both improves the user experience (via decreased latency) and improves the energy efficiency of the UE's battery, because receiving data in shorter bursts rather than over prolonged periods enables the UE to enter discontinuous reception (DRX) mode more often. In case of temporary radio channel degradation when no data can be transmitted over the air interface for a short time, the TCP Proxy does not timeout and revert to slow start in the downstream connections as a regular TCP sender would do, but instead continues the data transmission at full speed when the radio condition recovers.

Moreover, the approach discussed here differs from a non-integrated TCP Proxy in that a non-integrated TCP Proxy would start retransmitting data after timeout even if the same data were still available in the PDCP layer and would be transmitted by the radio stack. Such TCP level retransmissions are redundant (causing duplicate data to be received by the UE) and they are prevented by the integrated TCP Proxy architecture discussed here.

An additional capability provided by a TCP Proxy architecture according to embodiments of the invention is that such an architecture can ensure, or increase the probability, that the active TCP connections survive the handover to another eNB. When handover is triggered in the source eNB, the standard PDCP mechanism ensures that the PDCP PDUs are transmitted to the target eNB over the X2 interface. This approach automatically handles the transmission of those TCP segments that were already passed by the TCP Proxy transfer handler to the PDCP layer. In addition, the content of the TCP segment buffer (those segments that could not be transmitted to the UE due to AWND limitations) also need to be conveyed to the target eNB. This conveyance is achieved by sequentially transferring all segments from the TCP segment buffer to the PDCP layer. Thus, all pre-fetched data will be subject of the standard X2 data forwarding mechanism and arrive at the target eNB as X2 forwarded PDCP PDUs.

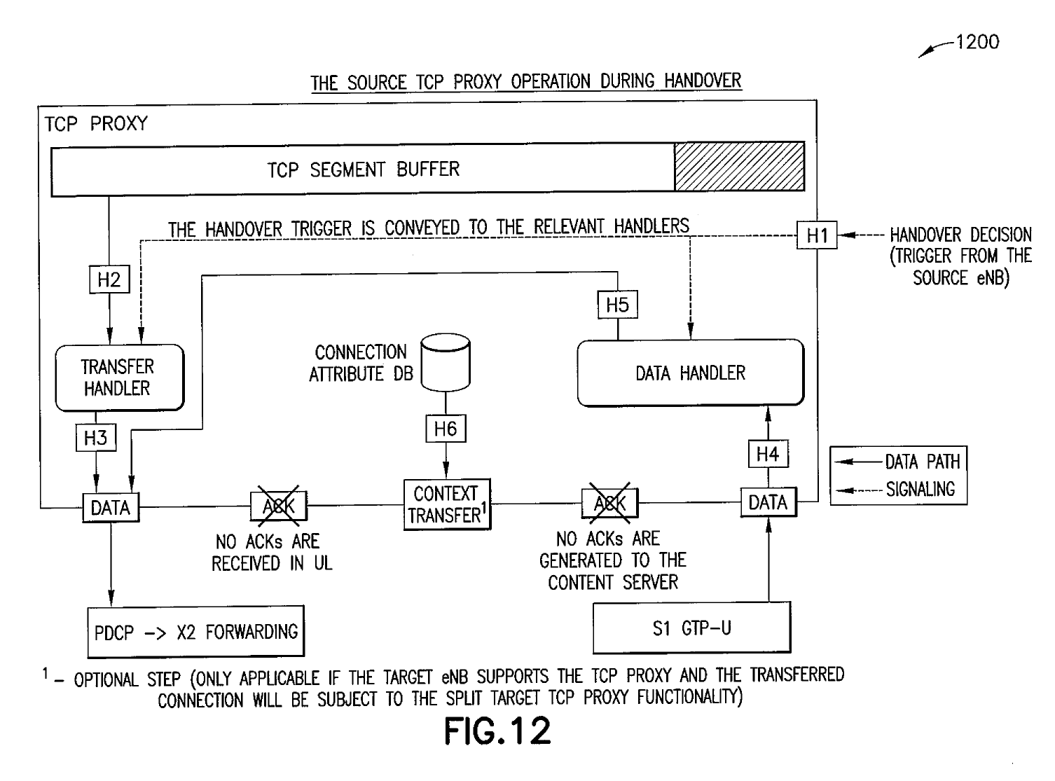

When the source eNB makes decision to handover a UE, it needs to inform the TCP Proxies that handle bearers corresponding to the UE, as illustrated in FIG. 12, presenting a diagram 1200. Internally, each notified TCP Proxy conveys the handover trigger to its data handler and transfer handler functionalities (step H1), which both change their operation as follows. Upon receiving the trigger, the transfer handler removes all segments from the TCP segment buffer (step H2) and transfers them to the PDCP layer through the PDCP SAP (step H3). This concludes the operation of the transfer handler as no additional segments will be stored in the TCP segment buffer any more. As this action happens atomically upon the handover trigger, it rules out the possibility of data loss during handover due to receiving the end marker before all per-fetched data is handed over to the PDCP layer through the PDCP SAP. The operation ensures that all per-fetched data will be subject of the standard X2 forwarding mechanism. The data handler may still receive TCP data segments from the content server (step H4) until the S1 path switch is completed. These segments are not acknowledged (as opposed to the normal operation) but they are also handed over to the PDCP layer so that they may also be sent to the target eNB. As these segments have not yet been acknowledged to the content server, their delivery to the target eNB is not mandatory because the content server could still retransmit them (it is, however beneficial for efficiency reasons). Finally, the TCP Proxy may need to execute an optional context transfer (step H6) depending on the TCP Proxy configuration at the target eNB, as discussed in greater detail below.

At the target eNB, two approaches may be taken depending on whether or not the target eNB supports the TCP Proxy.

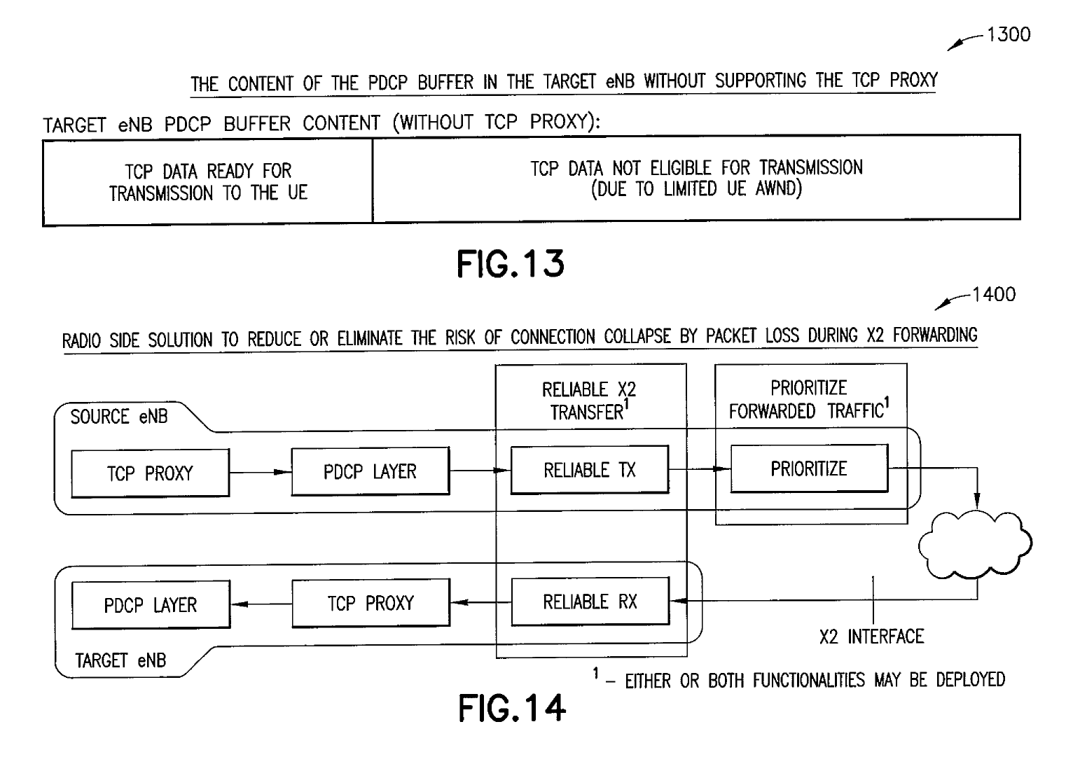

If the target eNB is a regular eNB without TCP Proxy functionality, the forwarded PDUs are going to be placed directly in the data bearer's PDCP buffer in the PDCP layer. Therefore, the PDCP buffer of the target eNB will store PDUs as depicted in FIG. 13, presenting a diagram 1300.

After the UE has completed the radio attachment to the target eNB and that target eNB has also received the GTP-U end marker via X2, it can begin transmitting data to the UE from the PDCP buffer. Meanwhile, new data may have already arrived from the content server directly to the target eNB, since the S1 path switch phase of the handover procedure has been completed. According to the GTP-U end marker mechanism, the segments received over the S1 interface are processed only after the end marker is received in the X2, granting priority to the forwarded pre-fetched data segments.

The beginning of the PDCP buffer contains PDUs that the source TCP Proxy has acknowledged back to the content server. While these segments are not any more in the scope of the content server, their availability at the target eNB's PDCP buffer guarantees their delivery to the UE over the air interface (due to the RLC AM operation). As the TCP Proxy preserves the end-to-end TCP context during the initial handshake of each connection (i.e., the usage of SACK or TimeStamp, the window scaling factor, sequence/ACK number ranges, etc.), the UE and the content server are fully synchronized and are able to continue the data transfer directly after the handover as follows. The target eNB will transmit data segments to the UE that were already acknowledged to the content server by the source TCP Proxy. The UE will send ACKs to those segments as they carry new data for the UE itself. Because there is no TCP Proxy in the target eNB, these ACKs will be received directly by the content server. For the content server, such ACKs correspond to data that has already been acknowledged. A standards compliant TCP sender should ignore these ACKs and not consider them as duplicates, and should not initiate any recovery procedure. Therefore, these ACKs cause no performance issues.

When the UE receives out-of-order data that was already acknowledged by the source TCP proxy, it will generate the same kind of ACKs that the source TCP Proxy has already generated did: in case SACK is supported, the UE will detect the same contiguous sequence number ranges and indicate the same gaps as did the TCP Proxy. If SACK is not supported, these segments will trigger regular duplicate ACKs in the UE just as well they did in the TCP Proxy.

Therefore, the content server will always receive a semantically consistent ACK flow before and after the handover even if there is no TCP Proxy in the target eNB. Further segments that were not yet acknowledged by the source TCP Proxy will deliver ACKs to the content server that are acknowledging new data; from that point, the TCP connection between the UE and the content server is fully joined.

The only potential problem that could happen after the handover with no TCP Proxy at the target eNB is due to the preliminary transfer of the AWND limited data segments. As the target eNB's PDCP layer has no concept of the AWND context of the segments, they may be sent to the UE rapidly in case of excellent radio condition. However, this potential problem is only present when the forwarded data contains AWND limited segments, which may not be the case in the first place. Additionally, such data transfer will not necessarily cause a real issue at the UEs; most TCP implementations (for example, current versions of Linux and Android) are capable of generously increasing their receive buffer on-the-fly if they detect that new data is arriving faster than it is processed. The upper limit of the increase (several Megabytes) is usually larger than the entire size of the PDCP buffer. Finally, the possibility of such problems is completely avoided in case there is a TCP Proxy at the target eNB as well.

If the target eNB does functionally support the TCP Proxy, it should create a TCP Proxy instance for all bearers transferred from the source eNB. Embodiments of the invention provide for two alternatives for handling the established TCP connections in the bearers: the connections can either become subject of the split TCP Proxy functionality in the target eNB (as if they had already been established in the target eNB) or they can bypass the split TCP Proxy functionality (but will be still monitored by the TCP Proxy). Applying the split TCP Proxy functionality at the target eNB requires additional context transfer (besides the X2 forwarding) from the source TCP Proxy to the target TCP Proxy. This requirement arises from the need of the TCP Proxy to be aware of the TCP capabilities and attributes of the transferred connections (for example, the SACK/TimeStamp capability is required to generate proper ACKs to the content server). The context transfer effectively means to convey the connection attribute database from the source TCP Proxy to the target TCP Proxy.

One possible implementation for the transfer is to include an additional Information Element (or set of IEs) to the standard X2-AP SN Status Transfer message, which may be sent from the source eNB to the target eNB during the handover execution. Alternatively, a proprietary message (one not part of standard X2 signalling) may also be defined. Such an approach does not require modification to 3GPP standards.

The data handler functionality of the target TCP Proxy receives the PDUs forwarded on the X2 interface as well as the segments that arrive on the target eNB's S1 interface (after the S1 path switch has been completed). For all segments, the data handler executes the normal D1-D5 workflow (as illustrated in FIG. 11 and discussed above) as the data handler does not need to differentiate between the X2 forwarded and S1 received segments.

One advantage of applying the split TCP Proxy functionality to the transferred connections in the target eNB is that the gain achieved by the TCP Proxy (due to the pre-fetched data) can be harvested for the transferred connections after the handover as well. The disadvantage is the additional complexity due to the context transfer. Therefore, an alternative implementation that does not require dedicated context transfer is to exclude the transferred connections from the split TCP Proxy functionality at the target eNB. Since in this case the connection attribute database starts as empty and thus contains records only for those connections that have been established at the target eNB, any data or ACK segment corresponding to a transferred connection can be recognized by not having a corresponding record in the database. In that case, the TCP Proxy creates a connection record with the bypass indication set to true (the value of the other attributes are irrelevant). Afterwards, the data-, ACK- and transfer handlers of the TCP Proxy operate according to their respective regular workflows depicted in FIG. 11.

In any of the above cases (with or without TCP Proxy in the target eNB, and whether bypassing the connections at the target TCP Proxy or not), the survival of the transferred TCP connections is assured as long as all critical X2 forwarded segments successfully arrive at the target eNB. If a segment that has been acknowledged by the source TCP Proxy is lost, it cannot be recovered because neither the content server, nor the target TCP Proxy or eNB have a copy of the data segment. A missing segment would cause a TCP connection collapse as the content server would fall into a dead lock (receiving duplicate TCP ACKs or SACKs for data it no longer has). Exemplary embodiments of the present invention provide for two solution alternatives to reduce the impact or eliminate the problem of permanently losing a per-fetched data segment: (A) radio side solution; and (B) core side solution.

(A) The radio side functionalities may be referred to as the X2 reliable transfer (requiring support from both the source and target eNB) and prioritization of X2 forwarded traffic (requiring support only from the source eNB), as shown in FIG. 14, presenting a diagram 1400.

The reliable X2 transfer requires a reliable transmission (TX) functionality at the source eNB and a reliable receive (RX) functionality at the target eNB. Due to the required support from both eNBs, having such a mechanism is reasonable only in case there is also a TCP Proxy in the target eNB. Therefore, the reliable RX and TX modules may be integrated with the TCP Proxy. One possible implementation of the reliable X2 transfer functionality extends the forwarded segments with Forward Error Correction (FEC) codes in such a way as to enable the receiver to reconstruct a specified number of lost segments from the added redundancy in the FEC parts of the received packets. Another implementation alternative simply duplicates each forwarded packet to provide 2N redundancy—receiving either of the two identical copies results in the successful transmission of the original segment. These alternatives only reduce the risk of having unrecoverable losses but do not completely eliminate it. Therefore, explicit retransmission mechanisms (for example, Automatic Repeat Request (ARQ) may also be implemented to guarantee completely error-free X2 transfer. In all cases, the functionality requires support from the target eNB/Proxy to perform the error correction decoding, de-duplication or any inverse mechanism required to recover and/or restore the received data stream to its original form.

Prioritization of the forwarded X2 traffic on the transport network, by contrast, does not require any support or even awareness from the target eNB, so that it constitutes a suitable alternative even if the target eNB does itself not support the TCP Proxy. However, this approach requires that the transport network infrastructure implement quality of service (QoS) queuing in the transport schedulers so that the prioritization is effective in congestion situations. The prioritization may be performed by setting the DSCP class in the outer IP address of the X2 GTP-U IP packets that carry the forwarded data from the source eNB to the target eNB. This approach requires that the TCP Proxy interface with the source eNB's transport module (that implements the X2 GTP-U interface) to request the required DSCP marking. Using the Expedited Forwarding (EF) code point (standard DSCP value 46) is suitable for prioritizing the forwarded traffic over most other traffic. Alternatively, any other DSCP value that provides sufficiently increased priority (according to the PHBs implemented in the transport schedulers) is suitable. The prioritization of the forwarded traffic may be used alone or in combination with the reliable X2 transfer functionality.

(B) The core side solution consists of a TCP Segment Cache residing in the core network. Suitable locations are the SAE-GW or a standalone entity on the Gn/SGi interfaces. The TCP Segment cache monitors the data segments sent by the content server in each connection and stores a copy of each downlink segment.

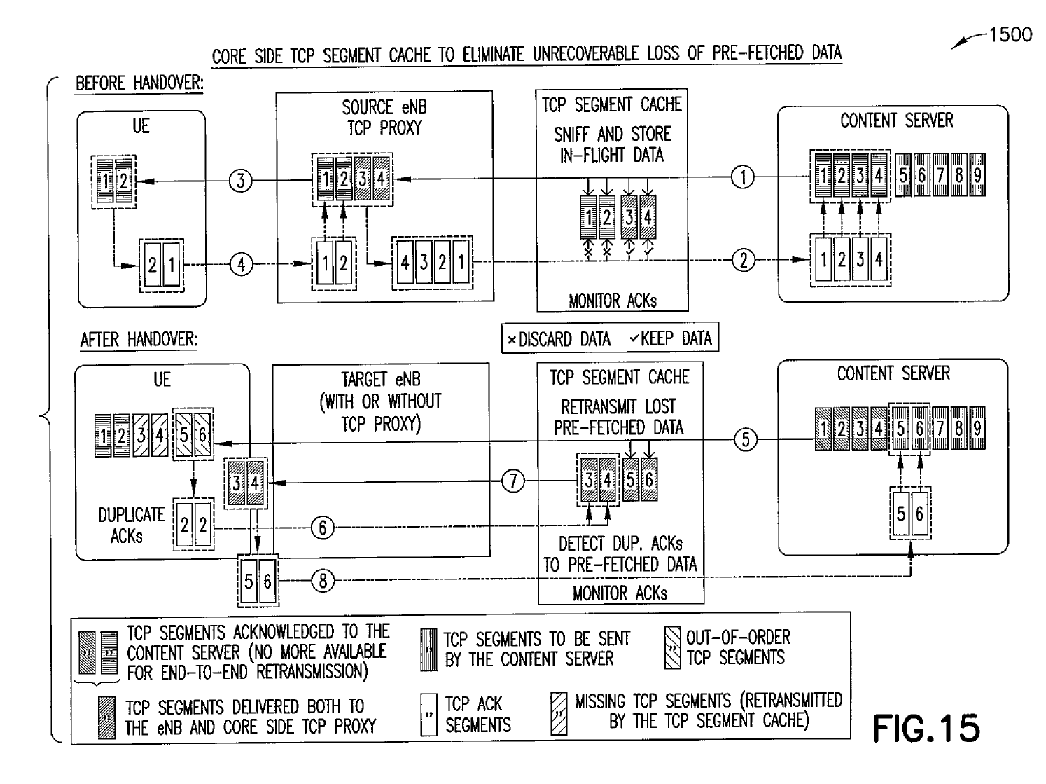

The TCP Segment Cache operates as a retransmission entity in case a pre-fetched data segment is lost during handover. The TCP Segment Cache monitors the uplink ACKs to detect if a retransmission is needed. If the TCP Segment Cache receives a duplicate ACK requiring the retransmission of a segment that is in its cache, it sends the data segment in downlink. Additionally, it discards the ACK that indicated the missing data so that it does not reach the content server. Similarly, in case SACK is used in the TCP connections, the TCP Segment Cache also monitors the SACK blocks to detect if the selectively acknowledged data ranges are intermitted by intervals of missing segments that correspond to data in its cache. Since the cache has a copy of all of the potentially lost segments, it is always able to retransmit the missing data. The operation of the TCP Segment Cache is illustrated in FIG. 15.

The core side solution alternative based on the TCP Segment Cache is less complex than is the radio side alternative and, in addition, always guarantees the survival of the TCP connections (as opposed, for example, to forwarding traffic prioritization, which is a lightweight mechanism but only reduces rather than eliminates the possibility of connection collapse). Additionally, the core side TCP Segment Cache is a generic solution, supporting handovers with or without TCP Proxy support at the eNB. However, various implementations of the radio side solution (for example, with the implementation of an ARQ mechanism between the source and target eNB or TCP Proxy) the radio side alternative can also be hardened to eliminate the possibility of packet loss during X2 forwarding and thus fully solve the handover problem. The radio side alternative may be attractive in case an operator has no influence on the core side infrastructure but still wants to deploy the eNB side TCP Proxy functionality for its performance boost without risking connection collapse due to handovers.

The operation of the TCP Proxy has been discussed with a primary focus on downlink data transmission, which constitutes the majority of the cases in a mobile network. However, the TCP Proxy can also handle uplink data transmission. In that case, the TCP Proxy receives data segments through the PDCP SAP and ACKs from the S1 interface. A feasible implementation is to transparently forward the data segments in uplink, whereas downlink ACKs are appended to the TCP segment buffer and transmitted in DL through the PDCP SAP whenever the first segment in the TCP segment buffer is an ACK. This is a reasonable approach as the TCP Proxy would not be able to achieve reasonable gain for these connections provided that the radio interface uplink is likely the bottleneck and thus no advance in the uploaded data can be reached.

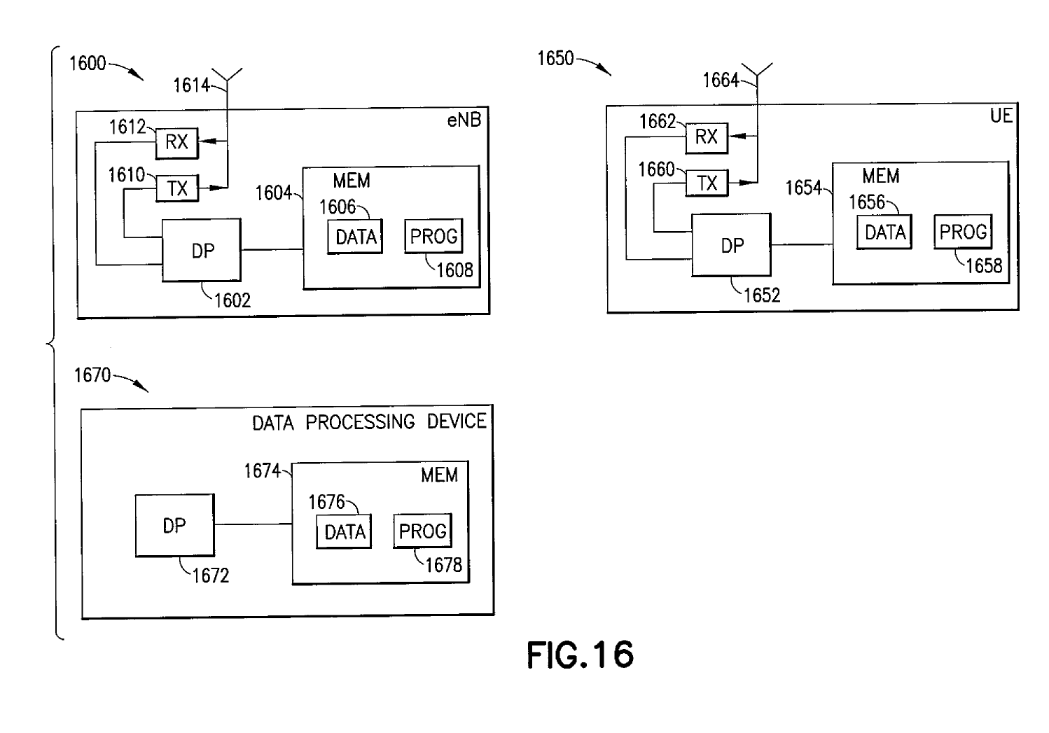

Reference is now made to FIG. 16 for illustrating a simplified block diagram of details of an eNB 1600, a UE 1650, and a data processing device 1670, of which one or more such data processing devices may serve as components of a core network such as the core network 206.

The eNB 1600 includes processing means such as at least one data processor (DP) 1602, storing means such as at least one computer-readable memory (MEM) 1604 storing data 1606 and at least one computer program (PROG) 1608 or other set of executable instructions, communicating means such as a transmitter TX 1610 and a receiver RX 1612 for bidirectional wireless communications with the UE 1650 via an antenna 1614.

The UE 1650 includes processing means such as at least one data processor (DP) 1652, storing means such as at least one computer-readable memory (MEM) 1654 storing data 1656 and at least one computer program (PROG) 1658 or other set of executable instructions, communicating means such as a transmitter TX 1660 and a receiver RX 1662 for bidirectional wireless communications with the eNB 1600 via one or more antennas 1664.

The data processing device 1670 comprises processing means such as at least one data processor (DP) 1672, storing means such as at least one computer-readable memory (MEM) 1674 storing data 1676 and at least one computer program (PROG) 1678 or other set of executable instructions.

At least one of the PROGs 1608 in the eNB 1600 is assumed to include a set of program instructions that, when executed by the associated DP 1602, enable the device to operate in accordance with the exemplary embodiments of this invention, as detailed above. In these regards the exemplary embodiments of this invention may be implemented at least in part by computer software stored on the MEM 1604, which is executable by the DP 1602 of the eNB 1600, or by hardware, or by a combination of tangibly stored software and hardware (and tangibly stored firmware).

Similarly, at least one of the PROGs 1658 in the UE 1650 is assumed to include a set of program instructions that, when executed by the associated DP 1652, enable the device to operate in accordance with the exemplary embodiments of this invention, as detailed above. In these regards the exemplary embodiments of this invention may be implemented at least in part by computer software stored on the MEM 1654, which is executable by the DP 1652 of the UE 1650, or by hardware, or by a combination of tangibly stored software and hardware (and tangibly stored firmware).

Similarly, at least one of the PROGs 1678 in the data processing device 1670 is assumed to include a set of program instructions that, when executed by the associated DP 1672, enable the device to operate in accordance with the exemplary embodiments of this invention, as detailed above. In these regards the exemplary embodiments of this invention may be implemented at least in part by computer software stored on the MEM 1674, which is executable by the DP 1672 of the UE 1670, or by hardware, or by a combination of tangibly stored software and hardware (and tangibly stored firmware).

Electronic devices implementing these aspects of the invention need not be the entire devices as depicted at FIG. 3 or may be one or more components of same such as the above described tangibly stored software, hardware, firmware and DP, or a system on a chip SOC or an application specific integrated circuit ASIC.

In general, the various embodiments of the UE 1650 can include, but are not limited to personal portable digital devices having wireless communication capabilities, including but not limited to cellular telephones, navigation devices, laptop/palmtop/tablet computers, digital cameras and music devices, and Internet appliances.

Various embodiments of the computer readable MEM 1604, 1654 and 1674 include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DP 1602, 1652, and 1672 include but are not limited to general purpose computers, special purpose computers, microprocessors, digital signal processors (DSPs) and multi-core processors.

In one embodiment of the invention, an apparatus comprises at least one processor and memory storing a program of instructions. The memory storing the program of instructions is configured to, with the at least one processor, cause the apparatus to at least create a transport control protocol (TCP) proxy during data bearer establishment at an eNodeB, with the TCP proxy being integrated with a packet data convergence protocol (PDCP) buffer of the new bearer, with the TCP proxy managing delivery of pre-fetched data to a UE so as to prevent TCP connection collapse during handover of a UE from a source eNB to a target eNB.

In another embodiment of the invention, the pre-fetched data is delivered to the target eNB immediately upon determination by the source eNB to handover the UE.

In another embodiment of the invention, the pre-fetched data is forwarded as part of a standard X2 forwarding procedure.

In another embodiment of the invention, the TCP proxy intercepts TCP connection establishments originated by a UE or a content server and creates separate upstream and downstream TCP connections so as to split the end-to-end TCP connection.

In another embodiment of the invention, a separate TCP proxy instance is created for each data bearer, with the TCP proxy instance for a bearer handling at least a relevant subset of the TCP connections within the bearer.

In another embodiment of the invention, the TCP proxy guarantees lossless X2 transfer of forwarded traffic.

In another embodiment of the invention, the TCP proxy, rather than guaranteeing X2 transfer of forwarded traffic, prioritizes forwarded traffic.

In another embodiment of the invention, an apparatus comprises at least one processor and memory storing a program of instructions. The memory storing the program of instructions is configured to, with the at least one processor, cause the apparatus to at least monitor end-to-end TCP connections before, during, and after a handover and maintain a TCP segment cache comprising a copy of each data segment that has been acknowledged by an eNB side TCP proxy, to monitor acknowledgements received in uplink and, if an acknowledgement received in uplink indicates data loss, retransmit the missing data from the cache.

In another embodiment of the invention, data is purged from the cache upon acknowledgement that the data has been delivered to a UE.

In another embodiment of the invention, a process comprises creating a transport control protocol (TCP) proxy during data bearer establishment at an eNodeB, with the TCP proxy being integrated with a packet data convergence protocol (PDCP) buffer of the new bearer, with the TCP proxy managing delivery of pre-fetched data to a UE so as to prevent TCP connection collapse during handover of a UE from a source eNB to a target eNB.

In another embodiment of the invention, a process comprises monitoring end-to-end TCP connections before, during, and after a handover and maintaining a TCP segment cache comprising a copy of each data segment that has been acknowledged by an eNB side TCP proxy. The method further comprises monitoring acknowledgements received in uplink, and, if an acknowledgement received in uplink indicates data loss, retransmit the missing data from the cache.

In another embodiment of the invention, a computer readable medium stores a program of instructions, execution of which by a processor configures an apparatus to at least create a transport control protocol (TCP) proxy during data bearer establishment at an eNodeB, with the TCP proxy being integrated with a packet data convergence protocol (PDCP) buffer of the new bearer, with the TCP proxy managing delivery of pre-fetched data to a UE so as to prevent TCP connection collapse during handover of a UE from a source eNB to a target eNB.

In another embodiment of the invention, a computer readable medium stores a program of instructions, execution of which by a processor configures an apparatus to at least monitor end-to-end TCP connections before, during, and after a handover and maintaining a TCP segment cache comprising a copy of each data segment that has been acknowledged by an eNB side TCP proxy, to monitor acknowledgements received in uplink, and, if an acknowledgement received in uplink indicates data loss, to retransmit the missing data from the cache.

While various exemplary embodiments have been described above it should be appreciated that the practice of the invention is not limited to the exemplary embodiments shown and discussed here. Various modifications and adaptations to the foregoing exemplary embodiments of this invention may become apparent to those skilled in the relevant arts in view of the foregoing description.

Further, some of the various features of the above non-limiting embodiments may be used to advantage without the corresponding use of other described features.

The foregoing description should therefore be considered as merely illustrative of the principles, teachings and exemplary embodiments of this invention, and not in limitation thereof.

1. An apparatus comprising:
at least one processor;
memory storing a program of instructions;
wherein the memory storing the program of instructions is configured to, with the at least one processor, cause the apparatus to at least:
create a transport control protocol (TCP) proxy during establishment of a new data bearer establishment at an eNodeB, wherein the TCP proxy is integrated with a packet data convergence protocol (PDCP) buffer of the new bearer; and
configure the TCP proxy so as to manage delivery of pre-fetched data to a user device so as to prevent TCP connection collapse during handover of the user device from a source eNodeB to a target eNodeB.

2. The apparatus of claim 1, wherein the TCP is further configured so as to deliver the pre-fetched data to the target eNodeB immediately upon determination by the source eNodeB to handover the user device.

3. The apparatus of claim 1, wherein delivery of the pre-fetched data is performed as part of a standard X2 forwarding procedure.

4. The apparatus of claim 1, wherein the TCP proxy is further configured to intercept TCP connection establishments originated by a user device or a content server and to create separate upstream and downstream TCP connections so as to split the end-to-end TCP connection.

5. The apparatus of claim 1, wherein the apparatus is caused to create a separate TCP proxy instance is created for each data bearer, with the TCP proxy instance for a bearer handling at least a relevant subset of the TCP connections within the bearer.

6. The apparatus of claim 1, wherein the TCP proxy is configured to guarantee lossless X2 transfer of forwarded traffic.

7. The apparatus of claim 1, wherein the TCP proxy is configured to assigned a predetermined elevated priority to forwarded traffic.

8. An apparatus comprising:
at least one processor;
memory storing a program of instructions;
wherein the memory storing the program of instructions is configured to, with the at least one processor, cause the apparatus to at least:
monitor end-to-end transfer control protocol (TCP) connections before, during, and after a handover and maintain a TCP segment cache comprising a copy of each data segment that has been acknowledged by an eNodeB side TCP proxy;
monitor acknowledgements received in uplink; and
if an acknowledgement received in uplink indicates data loss, retransmit the missing data from the cache.

9. The apparatus of claim 8, wherein the apparatus is further caused to purge data from the cache upon acknowledgement that the data has been delivered to a user device.

10. A method comprising:
creating a transport control protocol (TCP) proxy during establishment of a new data bearer establishment at an eNodeB, wherein the TCP proxy is integrated with a packet data convergence protocol (PDCP) buffer of the new bearer; and
configuring the TCP proxy so as to manage delivery of pre-fetched data to a user device so as to prevent TCP connection collapse during handover of the user device from a source eNodeB to a target eNodeB.

11. The method of claim 10, wherein the TCP is further configured so as to deliver the pre-fetched data to the target eNodeB immediately upon determination by the source eNodeB to handover the user device.

12. The method of claim 10, wherein delivery of the pre-fetched data is performed as part of a standard X2 forwarding procedure.

13. The method of claim 10, wherein the TCP proxy is further configured to intercept TCP connection establishments originated by a user device or a content server and to create separate upstream and downstream TCP connections so as to split the end-to-end TCP connection.

14. The method of claim 10, wherein the apparatus is caused to create a separate TCP proxy instance is created for each data bearer, with the TCP proxy instance for a bearer handling at least a relevant subset of the TCP connections within the bearer.

15. The method of claim 10, wherein the TCP proxy is configured to guarantee lossless X2 transfer of forwarded traffic.

16. The method of claim 10, wherein the TCP proxy is configured to assigned a predetermined elevated priority to forwarded traffic.

17-27. (canceled)
